(19) United States
(12) Patent Application Publication
(10) Pub. No.: US 2018/0174475 A1
(43) Pub. Date: Jun. 21, 2018

(54) APPLICATION FOR INTERACTIVE LEARNING IN REAL-TIME

(71) Applicant: BROADBAND EDUCATION PTE. LTD., Singapore (SG)

(72) Inventor: Raanan NEDIVI, Singapore (SG)

(21) Appl. No.: 15/821,828

(22) Filed: Nov. 23, 2017

Related U.S. Application Data
(60) Provisional application No. 62/425,625, filed on Nov. 23, 2016.

(51) Int. Cl. G09B 5/06; G09B 5/14; H04W 4/21; H04L 29/06; H04W 4/08

(52) U.S. Cl. CPC G09B 5/065; G09B 5/14; H04W 4/08; H04L 65/4038; H04W 4/21

(57) ABSTRACT

A framework for an interactive learning system is described herein. The system connects an end-user device to a virtual learning environment for an end-user to select a live training event within the virtual learning environment. Live video feed is delivered between a trainer of the selected live training event and the end-user. The virtual learning environment comprises a live chat facility for the end-user to communicate directly with the trainer and other end-users participating in the same live training event, wherein the live chat facility incorporates social media technology.

### CROSS-REFERENCE TO RELATED APPLICATION

This application claims the benefit of U.S. Provisional Application Ser. No. 62/425,625, filed on Nov. 23, 2016, which is herein incorporated by reference in its entirety for all purposes.

### FIELD OF THE INVENTION

The present invention is generally related to a networked platform for interactive learning. More specifically, the present invention is directed to an interactive virtual learning platform for multiple end-users.

### BACKGROUND

The development and deployment of technological social networking systems and the possibility of instant reach to information, particularly in a wireless environment has changed the way people learn and communicate today. Furthermore, mobile devices have become ubiquitous in today's society. Many people use mobile devices such as personal digital assistants (PDAs), laptops, tablet devices or any smart device in their daily lives. The development of a networked and connected world has resulted in mushrooming of social networks, which grant end-users the opportunity to connect with others in ways not possible before. However, little has been done towards providing people with a virtual learning platform that encourages social interaction between end-users.

Accordingly, there is a need for a computer implemented method and system that provides a learning experience through combining interactive learning opportunities with social interaction to provide the learner with higher levels of interest and involvement during learning activities.

### SUMMARY

A framework for an interactive learning system is described herein. In one embodiment, the system connects an end-user device to a virtual learning environment for an end-user to select a live training event within the virtual learning environment. Live video feed is delivered between a trainer of the selected live training event and the end-user. The virtual learning environment comprises a live chat facility for the end-user to communicate directly with the trainer and other end-users participating in the same live training event, wherein the live chat facility incorporates social media technology.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of various embodiments. In the following description, various embodiments of the present disclosure are described with reference to the following, in which:

FIG. 1 shows an embodiment of a framework for an interactive learning system.

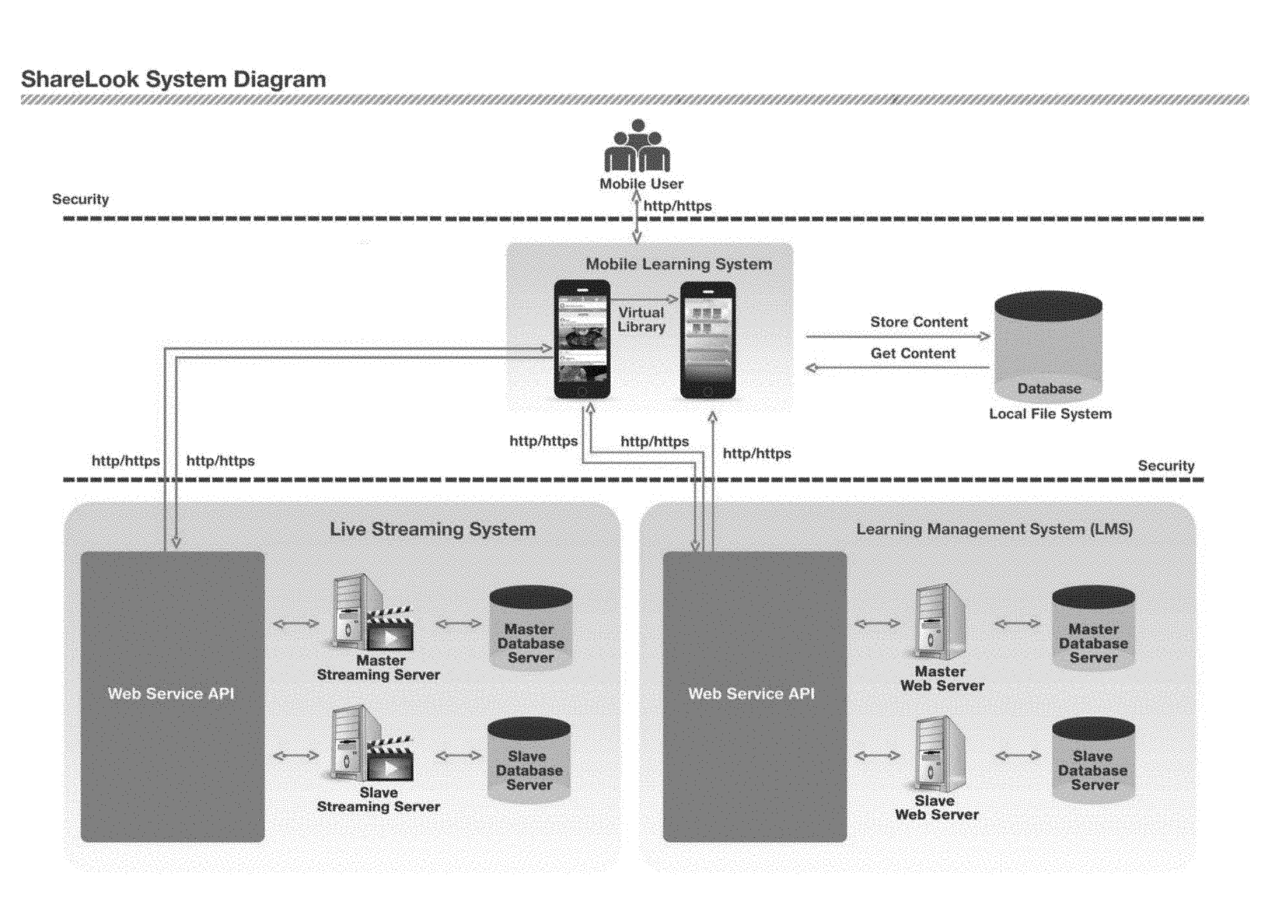

### DETAILED DESCRIPTION

A framework for an interactive learning system is described herein. The system is a software tool that allows content to be quickly created using a ‘lesson builder’ software architecture, which integrates multiple aspects of live training and education to create an interactive virtual learning platform for multiple end-users worldwide. For example, the system allows trainers to conduct and deliver training sessions (or training modules) to multiple end-users in real-time, and the trainers and end-users are able to interact among each other in real-time during the training session through a virtual learning environment.

The end-users may connect to the virtual learning environment using end-user devices. An end-user device may be a local computing device with a local memory and a processor. For example, the end-user device may be a personal computer (PC), a tablet PC, a workstation, a network computer, a kiosk or a mobile computing device, such as a laptop or a smart phone. Other types of computerized devices that process digital information may also be used. For example, the end-user device may also include a set-top box (STB) device, which connects a media device (e.g., television) to an external signal source. Connection to the virtual learning environment may be through the internet. The connection may be facilitated using a mobile telecommunication network, such as a 4G network. The system includes a backend subsystem and a frontend subsystem. The backend subsystem runs on a host server while the frontend subsystem runs on an end-user device.

In one embodiment, the end-user device is a mobile computing device and the frontend subsystem is developed to provide the end-user device with a mobile learning system. The frontend subsystem includes a simple and easy to navigate user interface for an end-user device. The user interface is, for example, designed around a “one click” philosophy. An end-user device may include a smart phone. In the case of a smart phone, the frontend subsystem may be downloaded to the end-user device as a mobile application (App) and installed on the end-user device. The App may be an e-learning (electronic learning) or m-learning (mobile learning) App. Other forms of frontend subsystem may also be provided, depending on the target end-user device. In one embodiment, the frontend subsystem integrates communication technologies, such as live video streaming, social media, instant messaging, and voice over Internet Protocol (VoIP) into an interactive virtual learning environment that is provided with traditional e-learning tools to deliver a live social learning (or training) experience. In one embodiment, the backend subsystem includes one or more databases and content management technologies, such as a content management system (CMS) and a learning management system (LMS), to allow end-users to consume learning materials online and offline.

In one embodiment, the software architecture of the backend subsystem facilitates the scheduling of live broadcasts of events (or live events) and defines relevant key words corresponding to each event. The live events include, for example, real-time broadcast of live training sessions conducted by trainers. In one embodiment, key word matching between archive data of a CMS and the live event is included as additional resource for a selected learning module. The system may support speech-to-text engine that allows an end-user to record or capture the contents of the live event and subsequently match the recording to the relevant archive data.

In one embodiment, the backend subsystem includes software specification that allows the system to collect data on various end-user activities from different technologies and track end-users' learning progress. For example, the LMS is able to track end-users' activities such as participation in live events, invites, questions raised, experience of training modules and trainers, push notification, archive video, and text from any session tagged for publication. This allows the system to give a detailed analysis on an end-user's performance and learning experience in the virtual learning environment. The backend subsystem includes, for example, an application programming interface (API) that facilitates e-learning, such as Tin Can API (or TinCan standard). Other suitable e-learning standards, such as SCORM (Sharable Content Object Reference Model) may also be useful.

In one exemplary implementation, the backend subsystem advantageously allows an employer to check if employees have improved their performance levels and shown a change in behavioral aspects after the live training sessions. The employer can also efficiently communicate with employees for feedback on the quality of the training sessions.

In one embodiment, the system enables and supports various live broadcast facilities to connect trainers and end-users in real-time. For example, a live streaming video facility delivers live video feed between trainers and end-users and a live chat facility allows an end-user to communicate directly with the trainer as well as other end-users participating in the same training module (or session). For example, end-users may share opinions and direct questions to the trainer or to another end-user in real-time through social media technology and/or other communication technologies. This provides end-users with an active learning experience. In one embodiment, the system may include a live quiz facility. For example, the trainer may selectively broadcast one or more quizzes in real-time to the end-users participating in a training module and the end-users' performance on the quiz may also be analyzed and broadcasted in real-time within the duration of the lesson. In another embodiment, the system includes a live poll facility. For example, the live poll facility enables trainers to broadcast questions to end-users and visualizes the end-users' corresponding answers in real-time during a training session. This provides the trainer with an overview of the end-users' understanding of a concept or topic and allows the trainer to adjust the training content during the training session to adapt to the end-users' learning progress. The system enables the trainer to create customized, quick ad-hoc content to share with multiple end-users in real-time and allows the trainer to quickly amend training content to enhance end-users' learning experience.

The system includes a collection of pre-defined content to complement the learning material delivered during live training sessions. In one embodiment, end-users may select from a collection of e-learning materials within the virtual learning environment to supplement their learning from the desired live training sessions. For example, end-users may select an online learning course related to a desired live training session before and after the session.

In one embodiment, the system can be activated, deactivated and modified by a text/SMS and/or chat system and/or phone or other inherent sensing systems which are integrated or nonintegrated. Modifications may be programmed into the system either through the framework of the system or remotely. The modifications may include activation and inactivation as well as the nature of the activity itself. In other embodiments, the modifications can include algorithms, predefined parameters, networks, activity, spontaneity, self-assembly, or network of the system. Learning algorithms can be implemented for optimization for future uses. Exclusivity and inclusiveness may be integrated into the system.

The above-described system advantageously integrates various mobile learning technologies with live broadcast facilities to deliver the desired content to multiple end-users. The system may provide static content, dynamic content, interactive content, streaming content, or a combination thereof. For example, the system integrates live training sessions with social media technology within a single virtual learning platform. Other types of content may also be provided. Although the system is described as being employed to deliver content for e-learning (or m-learning), it is appreciated that the system may also be employed for any other suitable applications which can utilize an interactive virtual environment with live broadcast facilities. For example, the system may also deliver content unrelated to learning. In an alternative embodiment, the system may also provide entertainment content for end-user consumption. For example, the system may also be employed to connect well-known personalities (e.g., celebrities) to the public for discussions, insights or other types of dialogue in real-time. Other applications of the system may also be useful.

What is claimed is:

1. A computer-implemented method for interactive learning comprising:
connecting an end-user device to a virtual learning environment, wherein an end-user selects a live training event within the virtual learning environment;
delivering live video feed between a trainer of the end-user selected live training event and the end-user; and
wherein the virtual learning environment comprises a live chat facility for the end-user to communicate directly with the trainer and other end-users participating in the same live training event, wherein the live chat facility incorporates social media technology.
